(19) United States
(12) Patent Application Publication
(10) Pub. No.: US 2010/0224506 A1
(43) Pub. Date: Sep. 9, 2010

(54) PROCESS AND APPARATUS FOR COMPLEX TREATMENT OF LIQUIDS

(76) Inventors: David Livshits, San Francisco, CA (US); Lester Teichner, Chicago, IL (US)

Correspondence Address: VEDDER PRICE P.C., 222 N. LASALLE STREET, CHICAGO, IL, 60601, US

(21) Appl. No.: 12/682,180

(22) PCT Filed: Oct. 9, 2008
(86) PCT No.: PCT/US08/79324

§ 371 Date: Apr. 8, 2010

Related U.S. Application Data
(60) Provisional application No. 60/978,927, filed on Oct. 10, 2007.
(60) Provisional application No. 60/978,924, filed on Oct. 10, 2007.

(51) Int. Cl. C02F 1/461; C02F 9/06

(52) U.S. Cl. 205/751; 204/284; 204/283; 205/742

(57) ABSTRACT

Methods and apparatus for complex treatment of contaminated liquids are provided, by which contaminants are extracted from the liquid. The substances to be extracted may be metallic, non-metallic, organic, inorganic, dissolved, or in suspension. The treatment apparatus includes at least one mechanical filter used to filter the liquid solution, a separator device used to remove organic impurities and oils from the mechanically filtered liquid, and an electroextraction device that removes heavy metals from the separated liquid. After treatment within the treatment apparatus, metal ion concentrations within the liquid may be reduced to their residual values of less than 0.1 milligrams per liter. A Method of complex treatment of a contaminated liquid includes using the separator device to remove inorganic and non-conductive substances prior to electroextraction of metals to maximize the effectiveness of the treatment and provide a reusable liquid.

### CROSS-REFERENCE TO RELATED APPLICATIONS

The present application claims priority to U.S. Provisional Application No. 60/978,927, filed on Oct. 10, 2007, and U.S. Provisional Application No. 60/978,924, filed on Oct. 10, 2007. The present application is related to PCT Application PCT/U.S.08/075,378, filed on Sep. 5, 2008, and is also related to PCT Application No. ______, filed on ______ (attorney docket 30029-002WO1). The disclosures of said provisional applications and said PCT applications, including the specification, claims and figures, are incorporated herein by reference.

### TECHNICAL FIELD

The current invention relates to the field of complex treatment of liquid media using various technologies.

### BACKGROUND

Obtaining clean water from liquids contaminated by discharge of industrial effluents as well as other anthropogenic activities and natural processes is of great social and economic importance. With particular attention to industrial effluents, contaminated liquids are produced as by-products of manufacturing processes in many industries. Such contaminated liquid solutions are typically water solutions that include many different types of contaminants, including substances which may be metallic (including dissolved ions of heavy metals), non-metallic, organic, inorganic, dissolved, or in suspension.

Conventionally, methods of treatment of liquids, including aqueous solutions containing ions of heavy metals together with organic substances, are based on various types of chemical coagulation techniques with subsequent sedimentation of the impurities, followed by removal and disposal and/or reclamation of sediments. These conventional methods require preparation of the liquids for coagulation, which may include chemical treatment of the liquid. However, such conventional methods sometimes produce a treated liquid which includes residual chemicals, as well as sediments which must be disposed of.

Reagent treatment is another conventional treatment technique in which chemical reagents are added to the liquid solution for bringing the liquid's acidity or alkalinity to a level which results in sedimentation of the contaminant. Although still in use at some older industrial plants, this method has major disadvantage and may often provide only low-quality purification.

Electrochemical processes are also known for use in treatment of contaminated liquids. The concentration of ions of heavy metals in water solutions can substantially influence the choice of electro chemical technology to be used for the treatment and clearing of the contaminated water solutions. Examples of electrochemical processes include electro-coagulation and electroextraction.

In an electroextraction process, a current is passed from a chemically inert anode through a liquid solution containing one or more metals so that metal is extracted as it is deposited in an electroplating process onto the cathode. Technology exists that allows for electrochemical sedimentation of heavy metals on the cathodes of electrochemical cells using galvanic sedimentation. In this process, additional treatment of the liquid solution is not necessary because the metal is yielded in a solid form. However, this advantage cannot be employed in industry for several important reasons. For example, many electroextraction processes may only be carried out at the starting concentrations of heavy metals exceeding 5 grams per liter. These processes are often incapable of purifying water to a degree permitting its reuse. In addition, the electroextraction process depends on the starting concentrations of mineral oil and common organic substances in water; their presence often diminishes the process speed and efficiency and hinders its use in an automated manufacturing environment. Moreover, the equipment used in this process is often complicated and can require stoppage for performing maintenance and service operations. Furthermore, some special modes of energizing the electrodes of a flow-through electrochemical reactor may result in hetero-coagulation, an effect that boosts the process of coagulation even when several different metals are dissolved in the liquid.

Electro-coagulation is a more advanced method with a number of applications. In an electro-coagulation process, precipitation of heavy metals (ions) from a liquid solution is achieved by adding ions of opposite charge to the liquid solution via an electrode pair. For example, an anode is dissolved within a flow of liquid to be treated, the anode being formed of a material causing formation of fluxes in the treated liquid. This has the effect of facilitating agglomeration or coagulation of the metals, resulting in separation of the metals from the liquid. However, the shortcomings of an electro-coagulation process often do not allow for its use as an integral part of modern flexible automated production processes. For example, in some cases the electro-coagulation process is very sensitive to the acidity level of the treated liquid. In a liquid with a noticeable acidity or alkalinity, the efficiency of flux formation and of the subsequent coagulation is low. As a result, a pre-adjustment of the liquid's acidity or alkalinity may be required in order to assure a reliable coagulation. Another considerable drawback is related to the post-treatment of sediments requiring disposal and/or reclamation. Various types of waste resulting from such a treatment may be toxic and require special technologies for their disposal and/or reclamation. At the same time the treated liquids often contain traces of the substances removed in the process of treatment, which usually renders the treated liquids unfit for reuse.

For the reasons described above, the conventional methods of water treatment may not provide the advantage of permitting wastewater regeneration and its reuse in the manufacturing process.

Because the contaminated liquids comprise such a broad variation in types of contaminants, a complex treatment of the liquid is required in which one or more treatment techniques are applied in a series of treatment steps to remove contaminants and thereby obtain clean water which can be re-used in industrial, agricultural and technological processes.

### SUMMARY OF THE INVENTION

A number of aspects of the current invention are directed to the complex treatment of a contaminated liquid solution by sequential application of treatment technologies. The complex treatment includes performing a preliminary selective separation of non-electrically conductive and nonmetallic substances from a liquid solution, followed by an electrochemical extraction of concentrated electrically-conductive substances from the liquid solution. The complex treatment of the liquid is achieved using apparatus and methods that exclude the use of chemical reagents, while assuring a substantially innocuous treatment by-product. That is, the treatment waste is substantially free of substances that would otherwise require special methods for its disposal and/or reclamation. In addition, the volume of waste and the level of residual substances in the treated liquid are reduced. As a result, a closed cycle of liquid regeneration is achieved. Moreover, when the treatment apparatus and method are used as part of an industrial process, full liquid recirculation within the process is obtained.

In some aspects, a treatment apparatus for complex treatment of liquids is configured to extract particular substances from a liquid solution. The substances to be extracted may be metallic, non-metallic, organic, inorganic, dissolved, or in suspension. In order to extract matter suspended in the liquid, the treatment apparatus may include at least one mechanical filter used to filter the liquid solution. A separator device is then used to remove organic impurities and oils from the mechanically filtered liquid. Within the separator device, the filtered liquid undergoes flotation, whereby organic impurities, oils, and other non-conductive impurities may be removed from the liquid. The treatment apparatus further includes an electroextraction device. In some examples, the electroextraction device is capable of removing heavy metals from contaminated water solutions containing electrically active components at starting concentrations varying in a range from about 5 grams per liter to a minimum of about 0.01 grams per liter. After treatment within the treatment apparatus, metal ion concentrations within the liquid may be reduced to their residual values of less than 0.1 milligrams per liter. In some examples, complex treatment of contaminated liquids within the treatment apparatus results in a clean liquid adequate for re-use in industrial processes.

In some aspects, the electroextraction device employs at least one reactor cell which includes a volume-porous electrode pair. The volume-porous electrodes permit three-dimensional flow through the porous electrode body, and provide an extensive and highly reactive surface area, whereby a considerable intensification of the electro-sedimentation process may be achieved as compared to electroextraction employing conventional electrodes. The electroextraction device also provides, concurrent with the metal extraction, a process of reduction and oxidation of toxic components in aqueous solutions, with the metal extraction performed at the cathode, and the decontamination of aqueous solutions performed at the anode. In some examples, these features of the electroextraction device are optimized by forming the volume-porous electrodes of composite material membranes.

In some aspects, the separator device employs flotation to achieve removal of organic impurities, oils, and other non-conductive impurities from the liquid, without the addition of chemical reagents to the liquid. The separator device includes at least one activator unit disposed within a lower portion thereof configured to receive a supply of compressed gas. The activator unit serves to introduce the compressed gas into the liquid, while violently agitating the gas and liquid together to form a mass of micro-bubbles, which rise upwards. In some examples, in the course of upward movement of the microbubbles, organic and other nonmetallic impurities present in the liquid are captured and suspended, resulting in a foam layer which forms on a surface of the liquid. The foam, which may include one or more of organic impurities, oils, and other non-conductive impurities, is then separated from the liquid.

In some aspects, a method of treating liquids that include conductive and non-conductive substances includes separating an organic substance and a non-conductive substance from a volume of liquid. The method also includes, subsequent to separating the organic substance and the non-conductive substance from the whole volume of liquid, treating a flow of the liquid by passing the liquid through a volume of electrodes. In some examples, the electrodes are electrically connected to a source of electric potential and are separated by a neutral membrane.

In some aspects, a method of treating a liquid that includes at least some of conductive substances, non-conductive substances, ions of heavy metals, organic substances, and inorganic substances includes physically treating a flow of the liquid using a filter. The method may also include, subsequent to physically treating the flow of the liquid, dividing the flow of liquid into a first phase and a second phase, the first phase comprising a liquid phase and the second phase comprising a foamy liquid and gas mixture. The method may also include treating a flow of the liquid phase within a permeable volume of electrodes electrically connected to a source of electric potential and separated by a neutral membrane.

In some aspects, a method of electrochemical regeneration of a liquid includes selectively separating organic substances and inorganic substances from an aqueous solution that includes ions of heavy metals to form a separated aqueous solution. The method may also include, subsequent to separating the organic substances and inorganic substances from the aqueous solution, electrochemically treating the separated aqueous solution by using gravitational force to pass the separated aqueous solution through permeable electrodes separated by a neutral membrane.

In some aspects, a method of electrochemical regeneration of an aqueous solution that includes ions of heavy metals, organic substances, and inorganic substances, includes selectively separating the organic substances from the aqueous solution in a reagent-free process to form a separated aqueous solution. The method may also include, subsequent to separating the organic substances from the aqueous solution, electrochemically treating the separated aqueous solution by passing, in a laminar mode, the separated aqueous solution through permeable electrodes. In some examples, the permeable electrodes can be formed of a nonmetallic material. In some examples, the electrodes can be disposed sequentially along a path of the aqueous solution movement and separated with a neutral membrane and the electrodes can be connected to a source of electric potential by an elastic permeable nonmetallic woven material.

In some aspects, a method of electrochemical regeneration of an aqueous solution includes separating organic substances from the aqueous solution by aerodynamic flotation and foaming in a reagent-free process to form a separated aqueous solution. The method may also include, subsequent to separating the organic substances from the aqueous solution, electrochemically treating the separated aqueous solution using electrochemical precipitation of metals onto surfaces of a permeable cathode separated from a permeable anode by a neutral membrane. In some examples, the permeable cathode is electrically connected to a source of electric potential by an elastic permeable nonmetallic woven material.

In some aspects, a method of electrochemical regeneration of metal-containing aqueous solutions includes performing an aerodynamic treatment of a volume of the aqueous solution using one or more aerodynamic activating devices. The method may also include forming a foam layer from the aqueous solution. The method may also include separating the foam layer from a remaining volume of the aqueous solution. The method may also include supplying of the remaining volume of the aqueous solution to an accumulating reservoir. In some examples, the accumulating reservoir includes at least two vertically installed electrochemical reactors. In some examples, the electrochemical reactors include three-dimensional porous electrodes and having an inlet to an inter-electrode space in the lower part of the reservoir and an outlet from the inter-electrode space in an upper part of the reservoir. The three-dimensional porous electrodes of the electrochemical reactors may be connected with at least two power supply units by an elastic nonmetallic conductive aqueous solution-permeable contact fabric. The method may also include performing electrical precipitation of metals from the aqueous solution. In some examples, performing electrical precipitation includes directing the aqueous solution through the accumulating reservoir, directing the aqueous solution into the inlet to the inter-electrode space, directing the aqueous solution across the anode, directing the aqueous solution through the membrane, directing the aqueous solution across the cathode and directing the aqueous solution out of the outlet from the inter-electrode space.

In some aspects, an apparatus for electrochemical regeneration of metal-containing aqueous solution of wastewater by selective separation of organic and inorganic components of the aqueous solution and electrical precipitation of metals onto a surface of negatively charged three-dimensional porous electrodes includes an aerodynamic module and an electrochemical module. The apparatus may also include an accumulating reservoir hydraulically interconnecting the aerodynamic module and the electrochemical module. The apparatus may also include a system of sources of electric potential electrically interconnecting aerodynamic module and the electrochemical module. In some examples, the sources of electric potential are electrically connected to each other and to electrodes of the electrochemical module by elastic permeable nonmetallic conductive fabric contacts.

In some aspects, an apparatus for electrochemical regeneration of aqueous solutions include one or more of ions of heavy metals, organic substances, and inorganic substances is provided. The apparatus may include a mechanism configured to separate organic substances and inorganic substances from the aqueous solution. The apparatus may also include a mechanism configured to electrochemically treat the aqueous solution by pressing the aqueous solution through permeable electrodes separated by a neutral membrane. In some examples, the permeable electrodes are electrically connected to a source of direct electric potential, and the connection to the source of direct electric potential may include an elastic permeable contact fabric.

In some aspects, an apparatus for electrochemical regeneration of aqueous solutions that include one or more of ions of heavy metals, organic substances, and inorganic substances is provided. The apparatus may include a mechanism configured to separate the organic substances from the aqueous solution in a reagent-free process to form a separated aqueous solution to generate a remaining solution. The apparatus may also include a mechanism configured to perform electrochemical treatment of the remaining solution. The mechanism configured to perform electrochemical treatment of the remaining solution may include a system configured to perform, in a laminar mode, hydraulic pressing of the remaining solution through permeable electrodes formed of a nonmetallic material and located sequentially along the path of the aqueous solution movement. In some embodiments, the anodes and cathodes of the permeable electrodes are separated by permeable neutral membranes and the anodes and cathodes are connected to a source of electric potential. In some embodiments, the connection to the source of electric potential may include an elastic permeable nonmetallic woven material that substantially encloses the permeable electrodes.

In some aspects, an apparatus for electrochemical regeneration of aqueous solutions that include ions of heavy metals in combination with organic and inorganic substances forming various metal-organic complexes with the ions of heavy metals may include an aerodynamic flotation and foaming module configured to separate organic substances from the aqueous solution in a reagent-free process to generate a remaining solution. The apparatus may also include a mechanism configured to electrochemically treat the remaining solution by electrochemical precipitation of metals onto surfaces of a permeable cathode. In some examples, the permeable cathode is separated from a permeable anode by a neutral membrane and connected to a source of electric potential by a conductive elastic permeable nonmetallic woven material.

In some aspects, an apparatus for electrochemical regeneration of a metal-containing aqueous solutions includes a mechanism for aerodynamic treatment of a volume of the metal-containing aqueous solution. The apparatus may also include an accumulating reservoir. The mechanism for aerodynamic treatment may include one or more aerodynamic activating devices configured to form a foam layer on the metal-containing aqueous solution, a device configured to separate the foam layer from the remaining volume of the aqueous solution, and a device configured to supply of the remaining volume of the aqueous solution to the accumulating reservoir. The accumulating reservoir may include at least two vertically installed electrochemical reactors. In some examples, the electrochemical reactors include three-dimensional porous electrodes. In some examples, the electrochemical reactors also include an inlet to an inter-electrode space in a lower part of the reservoir. In some examples, the electrochemical reactors also include an outlet from the inter-electrode space in an upper part of the reservoir. In some examples, the electrochemical reactors including at least two power supply units electrically connected to the three-dimensional porous electrodes of the electrochemical reactors by an elastic nonmetallic conductive aqueous solution-permeable contact fabric. The apparatus may also include a device configured to perform electrical precipitation of metals from the aqueous solution. The device configured to perform electrical precipitation of metals may be configured to direct the aqueous solution through the accumulating reservoir, direct the aqueous solution into the inlet to the inter-electrode space, direct the aqueous solution across the anode, direct the aqueous solution through the membrane, direct the aqueous solution across the cathode, and direct the aqueous solution out of the outlet from the inter-electrode space.

In some aspects, an apparatus for electrochemical regeneration of metal-containing aqueous waste water solutions includes an aerodynamic module and an electrochemical module. The apparatus may also include an accumulating reservoir hydraulically interconnecting the aerodynamic module and the electrochemical module. The apparatus may also include a system of sources of electric potential electrically interconnecting the aerodynamic module and the electrochemical module. In some examples, the sources of electric potential are connected to the electrodes of the electrochemical module by elastic permeable nonmetallic conductive fabric contacts. In the apparatus, an outlet of said aerodynamic module for outputting a treated liquid may be located above the accumulating reservoir and an inlet to the electrochemical module may be located at the same level as a bottom of the accumulating reservoir.

In some aspects, a method of treating a liquid solution is provided. The method may include separating organic substances and non-conductive substances from the liquid solution; and subsequent to separating organic substances and non-conductive substances from the liquid solution, electrochemically treating the liquid solution such that conductive substances are removed from the liquid solution.

In some embodiments, electrochemically treating the liquid solution comprises passing the liquid solution through a reactor. In some examples, the reactor includes a pair of volume-porous electrodes separated by a neutral membrane, and the electrodes are electrically connected to a source of electric potential such that one electrode is anodic and the other electrode is cathodic. In some examples, the liquid solution passes through a volume of each respective electrode of the electrode pair, whereby galvanic deposition of conductive substances on an active working surface of the cathodic electrode occurs.

In some embodiments, separating includes generating violent agitation within the liquid such that a foam comprising the organic substance and the non-conductive substance is formed on a surface of the liquid. In some embodiments, subsequent to electrochemical treatment, the method further comprises outputting a treated liquid that is substantially free of organic substances, non-metallic impurities, and metal ions. In some embodiments, the method is a reagent-free method such that no reagents are added during the method to enhance any of separation and electrochemical treatment.

In some embodiments, prior to separating an organic substance and a non-conductive substance from the liquid solution, the method further includes directing a stream of the liquid solution through a filter to generate a filtered liquid. In some embodiments, the liquid solution comprises conductive and non-conductive substances. In some embodiments, the liquid solution includes at least some of conductive substances, non-conductive substances, ions of heavy metals, organic substances, and inorganic substances.

In some aspects, a method of electrochemical regeneration of a liquid is provided. The method includes providing the liquid, the liquid comprising an aqueous solution that includes at least ions of heavy metals, selectively separating organic substances and non-conductive inorganic substances out of the liquid to form a modified solution, and subsequent to separating the organic substances and non-conductive inorganic substances out of the liquid, electrochemically treating the modified solution by using gravitational force to drive the modified solution through a pair of permeable electrodes of opposed charge, the electrodes separated by a neutral membrane.

In some embodiments, the aqueous solution further includes organic substances and inorganic substances. In some embodiments, the pair of permeable electrodes includes volume-porous electrodes, each electrode comprising a volume configured to permit fluid through-flow in three orthogonal directions. In some embodiments, selectively separating organic substances and non-conductive inorganic substances from an aqueous solution includes generating flotation within the aqueous solution such that the liquid separates into the modified solution and a second solution comprising the organic substances and non-conductive inorganic substances. In some embodiments, selectively separating organic substances and non-conductive inorganic substances from an aqueous solution includes generating flotation within the aqueous solution such that the liquid separates into the modified solution and a second solution comprising the organic substances and non-conductive inorganic substances, wherein the flotation generation is achieved without addition of chemical reagents to the aqueous solution.

In some aspects, a method of electrochemical regeneration of an aqueous solution is provided. The method includes separating organic substances from the aqueous solution in a reagent-free process by aerodynamic flotation of the aqueous solution to form a foam comprising the separated organic substances, and a separated aqueous solution. Subsequent to separating the organic substances from the aqueous solution, the method includes electrochemically treating the separated aqueous solution to achieve removal of metals from the separated aqueous solution.

In some embodiments, electrochemically treating the separated aqueous solution includes providing a reactor cell including a permeable cathode separated from a permeable anode by an electrically-neutral membrane, the permeable cathode being electrically connected to a source of negative electric potential by an elastic conductor, and passing the separated aqueous solution through the reactor cell. In some examples, the removal of metals from the separated aqueous solution is achieved through electrochemical deposition of metals onto surfaces of the cathode.

In some embodiments, the elastic conductor comprises permeable, nonmetallic, woven material. In some embodiments, electrochemically treating the separated aqueous solution comprises providing volume-permeable electrodes disposed sequentially along a path of the aqueous solution movement and separated with an electrically-neutral membrane, each electrode comprising a nonmetallic material and being connected to a source of electric potential by an elastic conductor, and passing the separated aqueous solution through permeable electrodes. In some embodiments, the elastic conductor comprises permeable, nonmetallic, woven material. In some embodiments, the aqueous solution includes wastewater containing ions of heavy metals in combination with organic and inorganic substances forming various metal-organic complexes with the ions of heavy metals. In some embodiments, the aqueous solution includes ions of heavy metals in either ionic or complex form.

In some aspects, a method of electrochemical regeneration of a metal-containing aqueous solution is provided. The method includes performing a flotation treatment of a volume of the aqueous solution using one or more activating devices configured to aerate and agitate the contents of said volume, forming a foam layer within the volume of the aqueous solution, separating the foam layer from a remaining volume of the aqueous solution and supplying the remaining volume of the aqueous solution to an accumulating reservoir, the accumulating reservoir including at least two vertically installed electrochemical reactors. In some examples, the electrochemical reactors include volume-porous electrode pairs, the volume-porous electrodes permitting liquid permeation through a volume of the electrode in three orthogonal directions, the volume-porous electrodes each connected with a power supply unit by an electrically-conductive contact such that one electrode of an electrode pair is an anode and the other electrode of the electrode pair is a cathode. The reactors may also include an electrically neutral membrane disposed between electrodes of an electrode pair, an inlet to an inter-electrode space in the lower part of the reservoir; and an outlet from the inter-electrode space in an upper part of the reservoir. In the method, electrical separation of metals from the aqueous solution may be performed by the following method steps: Directing the aqueous solution through the accumulating reservoir. Directing the aqueous solution into the inlet to the inter-electrode space. Directing the aqueous solution across the anode. Directing the aqueous solution through the membrane. Directing the aqueous solution across the cathode, and directing the aqueous solution out of the outlet from the inter-electrode space.

In some embodiments, the foam layer comprises inorganic and non-electrically conducting inorganic substances previously in solution within the metal-containing aqueous solution. In some embodiments, the method is a chemical reagent-free method. In some embodiments, the contact comprises an elastic, nonmetallic, aqueous solution-permeable fabric. In some embodiments, when the aqueous solution is directed across the anode, the metals become positively charged, and when the aqueous solution is subsequently directed across the cathode, the positively charged metals deposit on surfaces of the cathode, whereby metals are separated from the aqueous solution.

In some aspects, an apparatus for wastewater treatment is provided for wastewater that includes an aqueous solution including metals and metal ions, organic substances, and inorganic substances. The apparatus may include an aeration module configured to provide selective separation of organic and non-electrically conducting inorganic components of the aqueous solution from the aqueous solution. The apparatus may include an electrochemical module, the electrochemical module connected to the aeration module such that wastewater treated within the aeration module is hydraulically driven to the electrochemical module. The apparatus may also include a power supply and a control module which coordinates operation of the aeration module with operation of the electrochemical module. In some examples, the electrochemical module includes at least one pair of volume porous electrodes, the volume-porous electrodes each connected with the power supply by an electrically-conductive contact such that one electrode of an electrode pair is an anode and the other electrode of the electrode pair is a cathode, and the electrochemical module is configured to provide electrical deposition of metals from the wastewater treated within the aeration module such that the metals deposit onto a surface of the cathode.

The apparatus may include one or more of the following features: The contact comprises an elastic, liquid-permeable, nonmetallic fabric. The control module is configured to provide a pulsed source of electrical power to the electrodes.

In some aspects, an apparatus for treatment of an aqueous solution is provided. The aqueous solution may include one or more of ions of heavy metals, organic substances, and inorganic substances. The apparatus may include a separation device configured to separate organic substances and inorganic substances from the aqueous solution, and an electrochemical treatment device configured to electrochemically treat the aqueous solution such that conductive substances including ions of heavy metals are removed from the aqueous solution.

The apparatus may include one or more of the following features: The electrochemical treatment device includes at least one pair of volume porous electrodes separated by a neutral membrane, the volume-porous electrodes each connected with a power supply such that one electrode of an electrode pair is an anode and the other electrode of the electrode pair is a cathode, and the electrochemical treatment device is configured to electrochemically treat the aqueous solution such that electrical deposition of metals occurs on a surface of the cathode. The flow of the aqueous solution through a volume of the volume porous electrodes is achieved by pressing the aqueous solution through the volume, wherein pressing comprises use of gravitational force. The apparatus is configured such that the aqueous solution is delivered to the electrochemical treatment device subsequent to separation in the separation device.

In some aspects, an apparatus for electrochemical regeneration of an aqueous solution is provided. The aqueous solution includes one or more of ions of heavy metals, organic substances, and inorganic substances. The apparatus may include a separation mechanism configured to separate at least the organic substances from the aqueous solution in a reagent-free process. In some examples, the separation mechanism providing a separated aqueous solution which is organic-substance-free. The apparatus may include a reactor mechanism configured to electrochemically separate at least ions of heavy metals from the separated aqueous solution. The reactor mechanism may include volume-permeable electrodes disposed sequentially along a movement path of the separated aqueous solution. In some examples, the electrodes are separated with an electrically-neutral membrane. In some examples, each electrode includes a nonmetallic material and is connected to a source of electric potential by an elastic conductor. In some examples, the reactor is configured to hydraulically press the separated aqueous solution in a laminar mode through respective volumes of the electrodes.

The apparatus may include one or more of the following features: The elastic conductor comprises a liquid-permeable, nonmetallic fabric. The elastic conductor comprises a liquid-permeable, nonmetallic fabric that substantially entirely encloses the permeable electrodes. The elastic conductor comprises a viscose fabric saturated, in the course of a multi-stage pyrolysis, with graphite and displaying an absorption ability.

In some aspects, an apparatus for electrochemical regeneration of an aqueous solution is provided. The aqueous solution may include at least one of metals and metal ions. The apparatus may include an aeration device configured to dynamically aerate a volume of the aqueous solution, an accumulating reservoir, and at least two electrochemical reactors disposed within the accumulating reservoir. The aeration device may include one or more activators which dynamically activate the contents of the volume such that a foam layer is formed in the aqueous solution, a separating portion configured to separate the foam layer from the remaining volume of the aqueous solution; and a supply portion configured to supply the remaining volume of the aqueous solution to the accumulating reservoir. In some examples, the electrochemical reactors each include volume-porous electrodes, an inlet to an inter-electrode space in a lower part of the reservoir, an outlet from the inter-electrode space in an upper part of the reservoir, and at least one power supply unit electrically connected to the electrodes by an elastic contact. In some examples, the electrochemical reactor is configured to direct flow of the remaining volume of the aqueous solution through the inter-electrode space in a substantially vertically direction to generate electrical separation of metals from the remaining volume aqueous solution.

The apparatus may include one or more of the following features: The volume-porous electrodes include at least one pair of volume-porous electrodes separated by a neutral membrane, and each electrode is connected with the power supply by an electrically-conductive contact such that one electrode of the electrode pair is an anode and the other electrode of the electrode pair is a cathode. The apparatus is configured to direct the aqueous solution through the accumulating reservoir, direct the aqueous solution into the inlet to the inter-electrode space, direct the aqueous solution across the anode, direct the aqueous solution through the membrane, direct the aqueous solution across the cathode permitting electrical deposition of metals and metal ions onto a surface of the cathode; and direct the aqueous solution out of the outlet from the inter-electrode space. The at least one power supply comprises at least two power supplies. The elastic contact comprises a liquid-permeable, nonmetallic fabric. An outlet of the aeration device is located above the accumulating reservoir and an inlet to the electrochemical module is located at the same level as a bottom of the accumulating reservoir. A switching processor is provided that is configured to form electrical current pulses, and to apply the current pulses to the electrodes.

Modes for carrying out the aspects of the invention are explained below by reference to embodiments of the aspects shown in the attached drawings. The above mentioned aspects of the invention, other aspects, characteristics and advantages will become apparent from the detailed description of the embodiments presented below in conjunction with the attached drawings.

### BRIEF DESCRIPTION OF THE DRAWINGS

FIG. 1 is a schematic illustration of an apparatus for complex treatment of liquids.

FIG. 2A is a sectional view of a separator.

FIG. 2B is a sectional view of a foam generator.

FIG. 2C is a sectional view of the foam generator of FIG. 2B, showing liquid flow paths within the foam generator.

FIG. 3 is a sectional view of an electrochemical reactor cell.

FIG. 4 is a sectional view of an embodiment of an electrochemical reactor cell.

FIG. 5 is an end view of the electrochemical reactor cell of FIG. 4.

FIG. 6 is a first perspective view of the electrochemical reactor cell of FIG. 4.

FIG. 7 is a second perspective view of the electrochemical reactor cell of FIG. 4.

FIG. 8 is a perspective view of an electrically conductive band.

FIG. 9 is a side sectional view of a reactor module.

FIG. 10 is a perspective view of the reactor module of FIG. 8.

FIG. 11 is a schematic illustration of the treatment process using the apparatus of FIG. 1.

FIG. 12 is a schematic diagram of the control system of the apparatus for complex treatment of liquids.

### DESCRIPTION

An illustrative embodiment of an apparatus 100 for electrochemically processing liquids will now be described with respect to the figures. The apparatus 100 is configured to selectively separate organic and inorganic components of an aqueous solution and perform electrical precipitation of metals onto a developed active surface of negatively charged three-dimensional porous electrodes. Although one illustrative embodiment is described herein, it is understood that the inventive concepts disclosed herein are not limited thereto the illustrated embodiment. Moreover, it should be understood that only structures necessary for clarifying the present invention are described herein. Other conventional structures, and those of ancillary and auxiliary components of the system, are assumed to be known and understood by those skilled in the art.

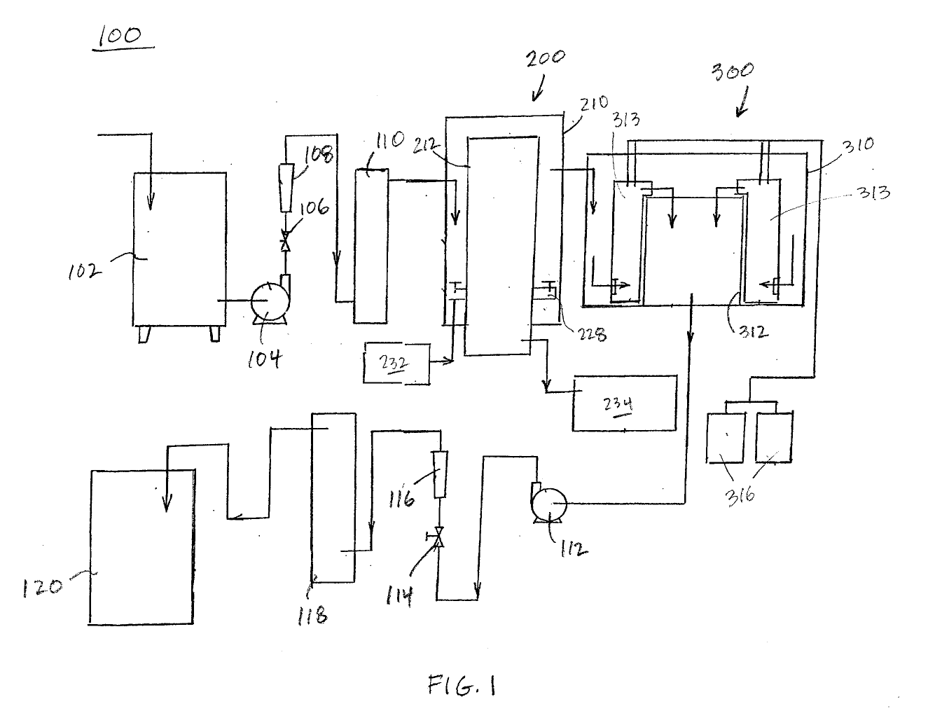

Referring to FIG. 1, an apparatus 100 for complex treatment of liquid comprises an input reservoir 102 for accumulating and storing a contaminated liquid prior to treatment. The liquid may be in the form of an aqueous solution, and in some aspects can include substances which are metallic (including dissolved ions of heavy metals), non-metallic, organic, inorganic, dissolved, or in suspension. In other aspects, the aqueous solutions can be wastewater. In still other aspects the aqueous solution can be wastewater containing ions of heavy metals in combination with organic and inorganic substances forming various metal-organic complexes with the ions of heavy metals. In still other aspects, the aqueous solution can include ions of heavy metals in either ionic or complex form.

The apparatus 100 further includes a pump 104. An inlet of the pump 104 is connected to, and draws liquid from, the internal volume of the reservoir 102. An outlet of the pump 104 is connected, through a flow rate adjustment valve 106 and a flow meter 108, with the inlet of a first mechanical filter 110.

The first mechanical filter 110 includes a screen configured to remove sediments and other non-dissolved particulate matter from the liquid. The filtering properties (e.g., pore size) of the filter 100 are selected based on the requirements of the specific application. By passing the liquid through the mechanical filter 110, sediments and other non-dissolved particulate matter are removed from the liquid received from the reservoir 102.

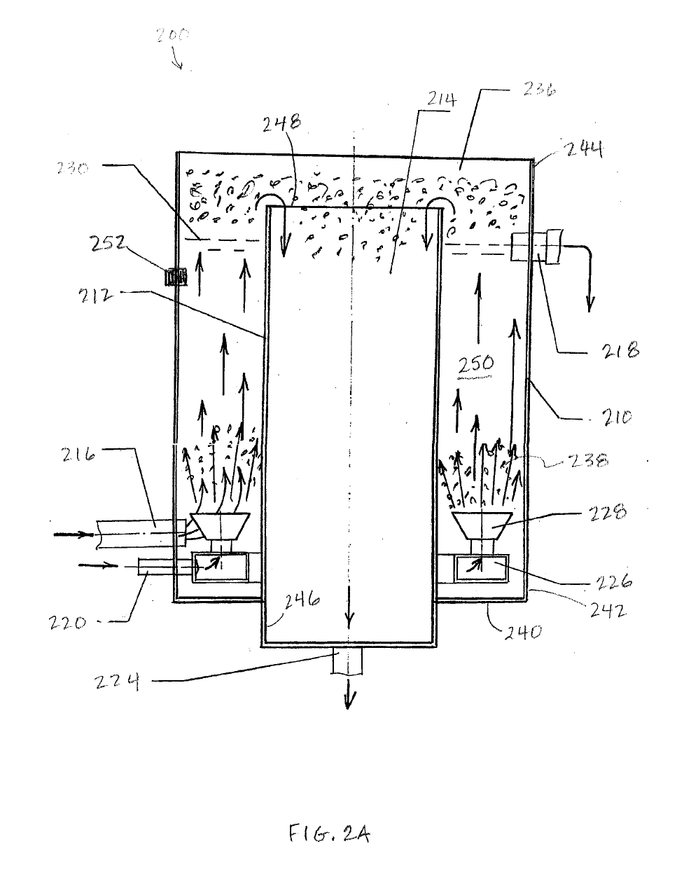

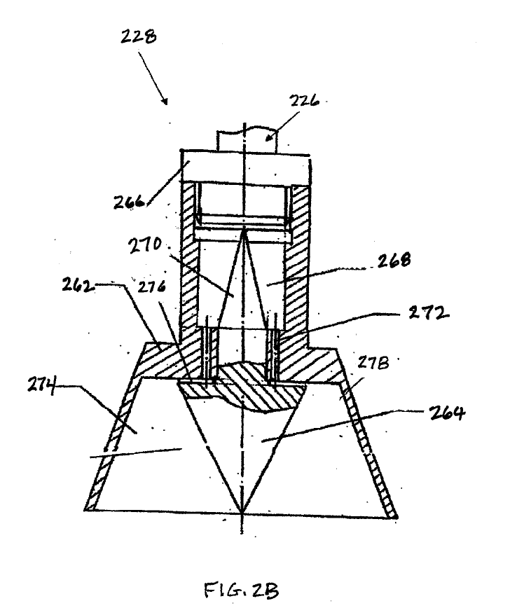

Liquid that has been filtered through mechanical filter 110 is directed into a separator device 200 (FIG. 2A) which aerates the liquid stream, dividing it into a first portion having a first phase and a second portion having a second phase.

The separator device 200 comprises a tank formed of an outer cylindrical housing 210 arranged coaxially with an inner cylindrical housing 212. A bottom surface 240 extends between a lower end 242 of the outer housing 210 and a lower end 246 of the inner housing 212 so that the tank is in the form of an annular trough 250. The inner housing 212 is arranged so that its open upper end 248 is disposed at a height which is lower than the height of the open upper end 244 of the outer housing 210. Liquid exiting the mechanical filter 110 is directed into the trough 250 via a liquid inlet 216 formed adjacent to the lower end 242 of the outer housing 210.

An annular gas manifold 226 is disposed within a lower portion of the trough 250, and receives a supply of compressed gas from a gas compressor 232 via a gas inlet 220 formed in the outer housing 210. In addition, several foam generating units 228 are disposed within a lower portion of trough 250 and are connected to the manifold 226 so as to receive a supply of compressed gas from the manifold 226. The foam generators 228 serve to generate foam within the annular trough 250 by introducing the compressed gas into the liquid, while violently agitating the gas and liquid together to form a mass of micro-bubbles 238 within the lower end of the trough 250.

Referring to FIGS. 2B and 2C, FIG. 2B shows a cross-sectional view of an exemplary foam generator 228 and FIG. 2C shows the flow of liquids and air within the foam generator 228 of FIG. 2B.

The foam generator 228 includes a generator housing 262 that receives a stream of compressed gas and transforms a direction of the flow of the compressed gas. The generator housing 262 is connected to a device 266 for input of the gas to the foam generator 228 which is connected to a pipeline (for example, manifold 226) allowing the input of gas into the foam generator 228 through the device 266 (as indicated by arrow 290). The generator housing 262 of the foam generator 228 forms a cavity 268 having a conical shape that receives the compressed gas from the pipeline 226.

A cone 270 is located inside the cavity 268 such that gas passing through the cavity 268 passes over the cone 270. The cone 270 has a conical shape with a tip pointing toward the end of the cavity 268 where the compressed gas enters from the pipeline 226. The inclusion of the cone 270 in the cavity 268 decreases the area in which the gas can flow and increases the pressure of the gas. The cone 270 also modifies the direction of the air flow in the foam generator 228 (as indicated by arrow 291) and directs the compressed air into a set of longitudinal channels 272 (as indicated by arrow 292).

The longitudinal channels 272 are distributed in regular intervals about the base of cone 270 and divide the stream of the compressed gas into capillary micro-streams of compressed gas. In general, the spacing of the longitudinal channels 272 and the number of longitudinal channels 272 can be based on the size of the foam generator 228. The longitudinal channels 272 are connected at one end to the cavity 268 near the base of the cone 270 and at the other end to a system of radial channels 276.

The radial channels 276 are disposed at an angle from the longitudinal channels 272 such that the compressed gas passing through the longitudinal channels 272 and into the radial channels 276 changes direction (as indicated by arrow 293). For example, the radial channels 276 can be disposed at about a ninety degree angle with respect to the longitudinal channels 272. The change in the direction of the airflow increases the turbulence in the airflow such that the gaseous working agent is dispersed at high speed, creating a local area of low pressure.

The reflector of a hydraulic part of the generator of foam, corresponding to cone 264 in FIG. 2B, has two basic functions. The external conical surface of the reflector distributes and allocates a volume of liquid, which is performed in a conical funnel, and distributes and allocates a liquid in such a manner that on the conical surface of a reflector, the liquid flows down in a bottom of a cavity 274 and cuts off a part of a stream of gas that moves in the radial channel 276.

The base of the cone 264 has a function of reflecting streams of gas that move in channels 272 and turning the specified streams in the channel formed by the bottom of the generator housing 262 and the base of the cone and forming a certain thickness of the moving stream of gas therein. The distance between a surface of the base of cone 264 and the bottom of generator housing 262 is equal to the diameter of the bubbles of gas that are formed in this channel. For example, the micro-bubbles are formed in this channel.

The reflector of an aerodynamic part of the generator of foam, corresponding to cone 270 in FIG. 2B, has a function of transforming a stream of gas in such a manner that a zone with a laminar level is not formed in the center of the stream. The cone 270 forces the gas stream out to the periphery of cavity 268 where the stream has a high level of turbulence, and then the stream is input into regularly dispersed channels 272, whose design eliminates aerodynamic resistance.

Due to the high speed of movement of the stream of compressed gas through the system of radial channels 276, when the compressed gas exits the system of radial channels 276 a local zone of low pressure 278 is formed at the point where the compressed gas exits the system of radial channels 276 (as indicated by arrow 294). Because of this low pressure, higher pressure liquid is drawn toward conical reflector 264 and toward low pressure zone 278. The liquid in a truncated conical cavity 274 is mixed with the air from the system of radial channels 276 in the local zone of low pressure 278. The liquid is delivered into the local zone of low pressure 278 through the cavity 274 (as indicated by arrow 310). The cavity 274 is conical in shape with a decreasing cross-sectional area such that the cavity 274 has a greater diameter at an entrance to the cavity and a smaller diameter near the low pressure zone 278. The decreasing diameter of the cavity 274 increases the turbulence in the flow of liquid in cavity 274. A cone 264 is located inside the cavity 274 such that liquid passing through the cavity 274 passes over the cone 264. The cone 264 has a conical shape with the tip of pointing toward the entrance to the cavity 274. The conical shape of the cavity 274 and cone 264 increases turbulence in the liquid due to the increased contact of the liquid with its surfaces.

The mixture of gas and liquid generates a pseudo-boiling volume in the low pressure zone 278 of the foam generator 228. The liquid and gas mixture flows away from the low pressure zone 278 and into an area with a larger diameter. The pressure in the liquid and air mixture increases as the pseudo-boiling volume flows away from the low pressure zone 278 forming a foam of micro-bubbles 238 of the liquid that exit the foam generator 228 and rise to the surface of the foam generator 228 (as indicated by arrow 296). As the microbubbles 238 are displaced from the low pressure zone 278, some of the bubbles of gas start to burst and turn to finer bubbles. Thus, foam leaves the area of the hydrodynamic conical reflector 264 and the liquid from the burst bubbles goes towards the jets of the gaseous working agent (rather than rising to a surface of the liquid in the cavity). This recycling of some of the liquid from burst bubbles creates additional turbulent flow and increased foam.

Due to their buoyancy, the micro-bubbles 238 rise upwards. In the course of the upward movement of the micro-bubbles 238, impurities present in the liquid adhere to the surfaces of the micro-bubbles 238, and are captured within the foam, and thus are suspended in a resulting foam layer 236 which accumulates on the surface of the liquid. Captured impurities may include one or more of organic matter, oil, heavy metals, minerals and oxides.

In this configuration, the foam 236 which accumulates on the surface of the liquid, and which contains captured impurities, is discharged over the upper end 248 of the inner housing 212 and is drawn down through the interior cavity 214 of the inner housing 212 by force of gravity. The foam 236 is directed to a storage tank 234 via a conduit 224. As a result, the organic and other nonmetallic impurities are separated from the liquid without addition of chemical reagents to the liquid solution.

The outer housing 210 further includes a liquid outlet 218 formed in the outer housing 210 at a height that is just below the height of the upper end 248 of the inner housing 212. While the foam is discharged over the upper end of the inner housing 212, the liquid, which risen to the upper portions of the trough 250 along with the micro-bubbles 238, has been substantially cleared of impurities, and exits the outer housing 210 via the liquid outlet 218.

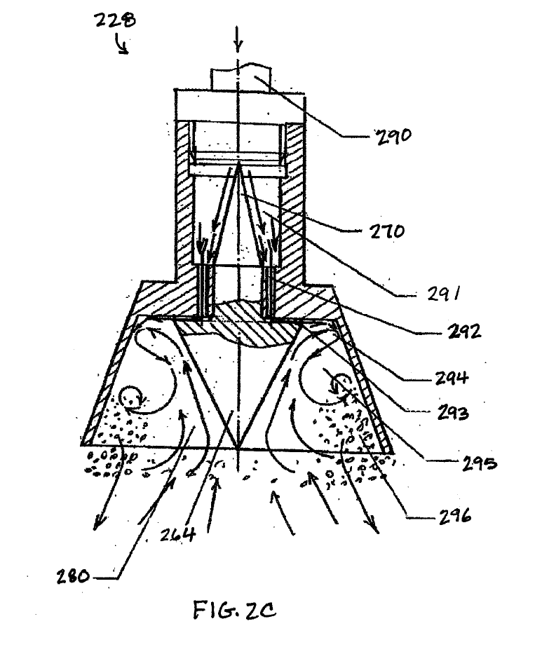

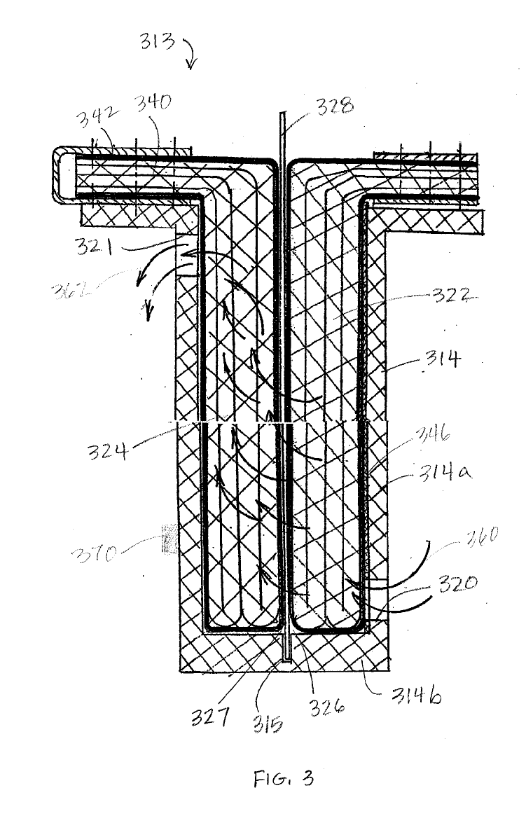

The liquid outlet 218 of the outer housing 210 communicates with, and directs liquid into an electrochemical reactor module 300 (FIG. 3). In some embodiments, the separator device 200 and the electrochemical reactor module 300 may be relatively arranged so that the liquid outlet 218 of the separator device 300 is located above the electrochemical reactor module 300 so that liquid flows under the force of gravity into the electrochemical reactor module 300. It is understood, however, that in alternative relative arrangements of the separator device 200 and the electrochemical reactor module 300, an external driving force may be used to direct liquids from the liquid outlet 218 to the electrochemical reactor module.

The electrochemical reactor module 300 includes module housing 301, which is discussed further below. A plurality of electrochemical reactor cells 313 are included in the module housing 301. In general, the electrochemical reactor cells 313 (FIG. 3) provide electrolytic extraction of metals from a liquid solution. As seen in FIGS. 3-7, the electroextraction cell 313 includes a cell housing 314. The cell housing 314 includes closed sidewalls 314a and a bottom 314b configured to form a container having an open upper end. The cell housing 314 is illustrated as having a vertically-elongated rectangular shape, but it is well within the scope of the invention to employ alternative shapes such as cylindrical or trapezoidal. The cell housing 314 is formed of a dielectric material. For example, the cell housing 314 may be formed of a chemically-inert plastic, such as, but not limited to, polypropylene.

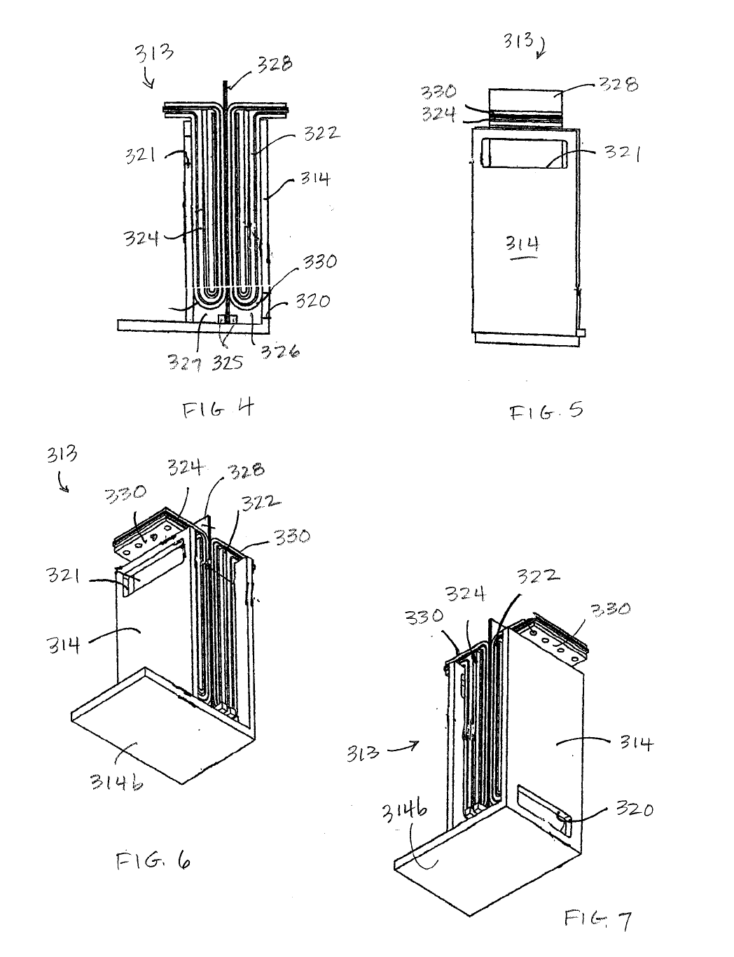

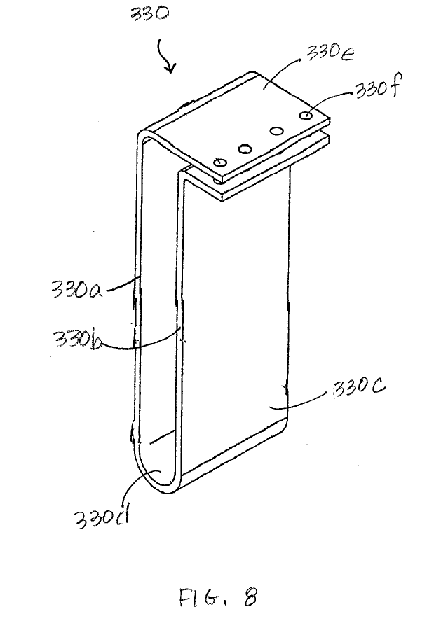

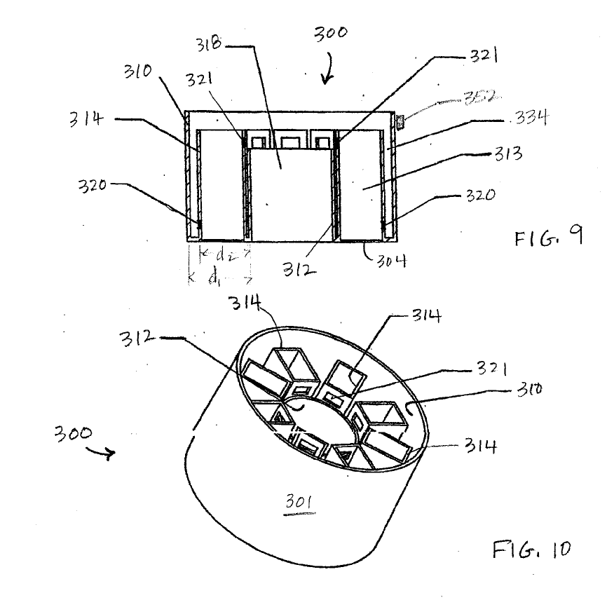

The cell housing 314 is segmented into two symmetric wells 326, 327 each having a separate well volume, using an electrically neutral membrane 328. Membrane 328 serves to electrically isolate liquids within the two wells 326, 327, effectively separating the electrical charge provided in the first well 326 from an electrical charge provided in the second well 327. Membrane 328 is a rigid, porous plate formed of a electrically neutral and chemically non-reactive fabric, the fabric being formed of materials such as, but not limited to, polypropylene or polyamide. In some embodiments, the membrane 328 is formed of a filtering fabric that includes polypropylene strings. The edges of the membrane 328 are fixed to the cell housing 314. In some embodiments, the edges of the membrane 328 are received in grooves 315 formed in the inner surface of the ell housing 314, whereby the position of the membrane 328 within the cell housing 314 is maintained (FIG. 3). In other embodiments, the edges of the membrane 328 are secured between parallel rails 325 provided on an interior surface of the housing 314 for that purpose (FIG. 4).

In the symmetric electrochemical reactor cell 313, the membrane 328 is positioned within the housing 314 so as to provide a first well 326 which has substantially the same working volume as the second well 327. The membrane 328 may be provided having a thickness in a range from about 0.2 mm to about 1 mm (for example, from about 0.2 mm to about 0.4 mm, from about 0.3 mm to about 0.5 mm, from about 0.6 mm to 0.9 mm, and from 0.8 mm to 1.0 mm). In some aspects, the membrane 328 is formed having a maximum thickness of less than about 0.5 mm. The membrane 328 provides a region of reduced flow volume between the electrodes, creating an active zone having a small volume relative to the corresponding volume without a membrane 328. The effect of the region of reduced flow volume is to accelerate fluid flow from the first well 326 to the second well 327.

An inlet opening 320 is formed in the sidewall of the housing 314 adjacent to the bottom of the cell housing 314. The inlet opening 320 permits input of a liquid requiring treatment and processing into the internal cavity of the cell housing 314. Specifically, the inlet opening 320 permits fluid flow into the first well 326. In addition, an outlet opening 321 is formed in the sidewall adjacent to an upper edge of the housing 314. After treatment and processing of the liquid, the outlet opening 321 permits output of the liquid from the well 327. Specifically, the outlet opening 321 permits fluid flow to the exterior of the cell 313. As seen in FIGS. 5-7, the inlet opening 102 and outlet opening 103 are provided having a width that extends substantially across a width of the respective housing side so as to maximize fluid flow into and out of the housing 314.

A first electrode 322 is disposed within the first well 326, and a second electrode 324 is disposed within the second well 327. During processing of the contaminated liquid, the first electrode 322 is connected with a source of positive electric potential, and the second electrode 324 is connected with a source of negative electrical potential, provided, for example, by one or more power supply units 316. In some embodiments, the power supply units 316 are interconnected by means of an electrical circuit such that sources of electric potential can be connected to the respective electrodes 322, 324 and their respective conductive bands 330 by a switching processor 160 (FIG. 12). The switching processor 160 is configured to form electrical current pulses and apply the pulses in a predetermined order to the electrodes 322, 324 and their respective conductive bands 330.

The first and second electrodes 322, 324 are formed to be substantially structurally similar. For this reason, only the structure of the first electrode 322 will be described herein.

The first electrode 322 is made of a carbon carbon composite material, graphitic cotton wool, graphitic carbon wool, coal carbon wool or from coal cotton wool. For example, in some embodiments, the first electrode 322 is formed of coal carbon wool, which is an electrically conductive fabric that is chemically inert, flexible, can withstand very high temperatures, and can be formed into a desired shape. The coal carbon wool is pressed into plates, each plate having a thickness of approximately 5-8 mm. Each plate is folded back on itself one or more times, and one or more folded plates are stacked to obtain a volume of material which is approximately the size of the first well 326. Thus, the electrode 324 is sized and shaped to fit within, and substantially fill, an interior space of the first well 326 such that the active working volume of the first electrode 322 generally corresponds to the volume of the first well 326. The volume of the first electrode 322 is determined by the requirements of the specific application, and is based on requirements for the productivity of the electroextraction cell 313. As an example, for a cell 313 in which a flow rate of up to three cubic meters per hour is required, a corresponding electrode 322 would have a volume measured in cubic centimeters. Of course, requirements of greater flow rates can be accommodated by electrodes having volumes measured in cubic meters.

At one end of the first electrode 322, the stacked plates of coal carbon wool are bent and compacted into a substantially rectangular compressed region 340. The end of the first electrode 322 is bent in a direction away from the corresponding end of the second electrode 324, whereby inadvertent contact of the electrodes 322, 324 is avoided, and overall height of the electrochemical cell 313 is reduced. In some embodiments, compressed region 340 has an alternative shape, such as cylindrical. In some embodiments, the compressed region 340 may surrounded by a correspondingly-shaped metal plug 342, which in turn is connected to a source of positive electric potential 201. Compression of the electrode material in the compressed region 340 promotes efficient transfer of electrical charge from the plug 342 to the electrode material.

The above described electrode configuration provides a porous electrode of a predetermined working volume, the working volume defined by the dimensions of the volume of the carbon-carbon wool material disposed within the first well 326. It is understood that, due to the large surface area inherent to the carbon carbon wool fabric, and because the fabric permits liquid to pass through the entire working volume of the electrode, a very large active working surface area is provided within the working volume. In addition, the electrode configuration permits liquid to pass through the working volume in three orthogonal directions.

The first electrode 322 is bound by an elastic conductive band 330, and another elastic conductive band 330 surrounds the second electrode 324. The conductive band 330 made of a carbon composite fabric created by a multi-step pyrolysis process in which a viscose fabric matrix is saturated with carbon (graphite). The resulting band structure is non-metallic, electrically conductive, porous, elastic, absorptive, and flexible. The band 330 is wrapped about the electrode in a stretched configuration so that it remains in place due to the elastic properties of the band 330 and so that good electrical contact is made between the band 330 and first electrode 322. The conductive band 330 surrounds at least a portion of the outer periphery of the first electrode 322. In some embodiments, the band 330 is in the form of a strip that extends about a circumference of the electrode.

For example, the conductive band 330 may be formed in a U-shape (FIG. 8), including a closed lower end 330c joining opposed first 330a and second 330b band sides. The electrode 322 may be press fit between the opposed band sides 330a, 330b such that a lower end of the electrode abuts against the inner surface 330d of the lower end 330c of the conductive band 330. The upper portion of the opposed first and second sides may be bent to correspond to the bent shape of the electrode 322, and may also include connectors 330f for connecting to an external source of electric power. In other aspects, the conductive band 330 may be provided in other shapes such that the outer peripheral surfaces of the first electrode 322 may be essentially enclosed by the conductive band 330. In addition, the conductive band 330 is directly connected to a source of positive electric potential. The ends of the conductive band 330 are provided with vertically aligned holes 330f, and an electrical conductor from a power source passes through the upper hole 330f, through the electrode 322, and through the corresponding lower hole 330f.

The first electrode 322 is disposed within the first well 326 so as to be interposed between the membrane 328 and the sidewall 314a. In some embodiments, a rigid plate 346 may optionally be used to maintain a desired geometric shape of the first electrode 322. As seen in FIG. 3, a rigid plate 346 is disposed between the sidewall 314a and conductive band-covered side of the first electrode 322.

The first electrode 322 serves as an anode due to its connection with a source of positive electric potential through metal plug 342 which acts in the compressed region 340, and through the conductive band 330, which acts along the entire outer periphery of the first electrode 322. This configuration provides an electrode in which the charge density over the electrode 322 is highly controllable and substantially uniform throughout its volume.

In a similar manner, the second electrode 324 is disposed within the second well 327. The second electrode 324 is formed to have a volume of material which is approximately the size of the second well 327. The second electrode 324 is bound by a conductive band 330, which is connected with a source of negative electric potential through a metal plug 340. As a result, the second electrode 324 serves as a cathode.

In summary, the cell 313 for electrolytic extraction of metals from metallic liquids includes a housing 314 segmented into at least two generally symmetric wells 326, 237 separated by an electrically neutral, porous membrane 328, an electrode 322, 324 disposed within each well, at least one source of constant electric potential connected to the electrodes, and a covering 330 on the external surface of the electrodes, the covering 330 providing a porous, elastic, nonmetallic woven contact for connection to a source of constant electric potential. The electrolytic cell 313 further includes an input 320 for inputting of a metal-contaminated liquid into the volume of the first electrode 322, which is connected to a source of positive electric potential, and an output 321 for outputting the processed liquid from the volume of the second electrode 324, which is connected to a source of negative electric potential.

The following tables provides examples of technical parameters of the illustrated embodiment of the electrolytic cell 313:

| | |
|---|---|
| DC current load per one electrochemical | 150 A |
| reactor | |
| Voltage | 6 to 12 V |
| Number of anode chambers | 1 |
| Number of cathode chambers | 1 |
| Maximum amount of metal precipitated at | 8 kg |
| the electrochemical reactor's cathode | |
| Percentage of metal extraction | 99.5% |
| Production capacity | 0.3 cubic meters per hour |

Due to the high rate of the liquid exchange at the volume-porous electrodes' active surface which corresponds to the extensive surfaces provided within the volume of the electrodes, it is possible to raise the effective current density by a factor of 10 relative to that of conventional electrochemical reactors with planar electrodes, resulting in a 100-fold increase in the production capacity of the cell, and in the metal extraction speed.

Of a special importance is the design of electrodes 322, 324, particularly the pioneering design of elastic conductive bands 330 manufactured of a composite viscose based fabric pyrolytically saturated with carbon. The conductive bands 330 are is completely chemically inert, and assure electrical connection over substantially the whole electrode surface, which reduces the current loss, and avoids the destruction which occurs when conventional metallic contacts are used within an electrochemical reactor.

Referring again to FIG. 3, operation of an individual cell 313 will now be described in detail. In operation, the liquid to be treated and processed is forced to enter inlet opening 320. The liquid may be driven using conventional techniques, which may include using the influence of forces of gravitation, and/or pumping. In the preferred embodiment, the housing 314 is disposed within an module housing 301 filled with the liquid to be treated, whereby the head of liquid above the inlet opening 320 generates the required driving force.

The stream 360 of the liquid to be processed, enters the first well 326 in a laminar mode and moves inside the working volume of the first electrode 322 by passing through porous contact 330. At this time, the working volume of the first electrode 322 is under the influence of positive electric potential, owing to the connection of contact 330 and metal plug 342 to the source of positive electric potential, provided by a power supply 316. Under gravitational force, the liquid rises upwards in the working volume of electrode 322, and under influence of the same forces, filters through the membrane 328 into the second well 327. Within the second well 327, the liquid passes through conductive band 330 into the internal working volume of the second electrode 324, which is connected to a source of negative electric potential, provided by the power supply 316. Metal ions, being positively charged due to passage through the working volume of the positively charged first electrode 322, are attracted to the surfaces of the negatively charged second electrode 324, and thus are extracted from the liquid. After being processed through the working volume of the second electrode 324, the treated, substantially metal-free liquid leaves in stream 362 through the output opening 321.

In this embodiment, since the working volume of the respective electrodes 322, 324 is substantially the same as the volume of the corresponding well 326, 327, the distance between electrodes is determined only by the thickness of the membrane 328. As a result, this distance is only a maximum of about 0.8 to 1.0 mm, and may be as little as 0.2 mm, whereby the efficiency of the galvanic pair is very high.

Moreover, the entire volume has an active galvanic function. Specifically, from the moment of input of a liquid into the working volume of the second electrode 324, which is connected to a source of negative electric potential, a high-speed process of electro-sedimentation of the metals begins.

The volumetric structure of the electrodes 322, 324, which are made from carbon fibers, results in a significantly large active working surface area within the respective electrodes 322, 324. This large active working surface area is provided with a source of uniform, constant electric potential. In some aspects, at least about 50% of the active working volume of the one or more electrodes of the electrode cell is provided with this uniform, constant source of electric potential, and as much as about 99% or more of the active working volume of the one or more electrodes of the electrode cell may be provided with the uniform, constant source of electric potential. This is turn results in a significant gain of the electro-sedimentation of metals is achieved on the surface of the carbon fibers from an increased current density in the electrode relative to conventional electrodes.

The electroextraction cell 313 can also include a sensor 370 located on an external surface of the housing 314 in the vicinity of the cathode 324. The thickness of a cathode metal sedimentation is determined by a means of the sensor 370, which may be a magnetic resonance sensor. In use, the cathode metal can be configured such that for a specific definition of the thickness of the cathode metal the electrical resistance of the cathode is changed, and the change in resistance is determined by the sensor 370.

As described above, metal ions are attracted to the surfaces of the negatively charged second electrode (cathode) 324, and thus are extracted from the liquid. The metal is deposited within the cathode's 324 volume. After the internal volume of the cathode 324 is filled with metal, the cathode may be removed from the cell 313 and a new cathode 324 may be installed and the process can be repeated. Metal can be subsequently be removed from the electrode 324 as an ingot using pyrometallurgic, electrochemical or chemical methods processes.

Module Including Plural Symmetric Electrode Cells

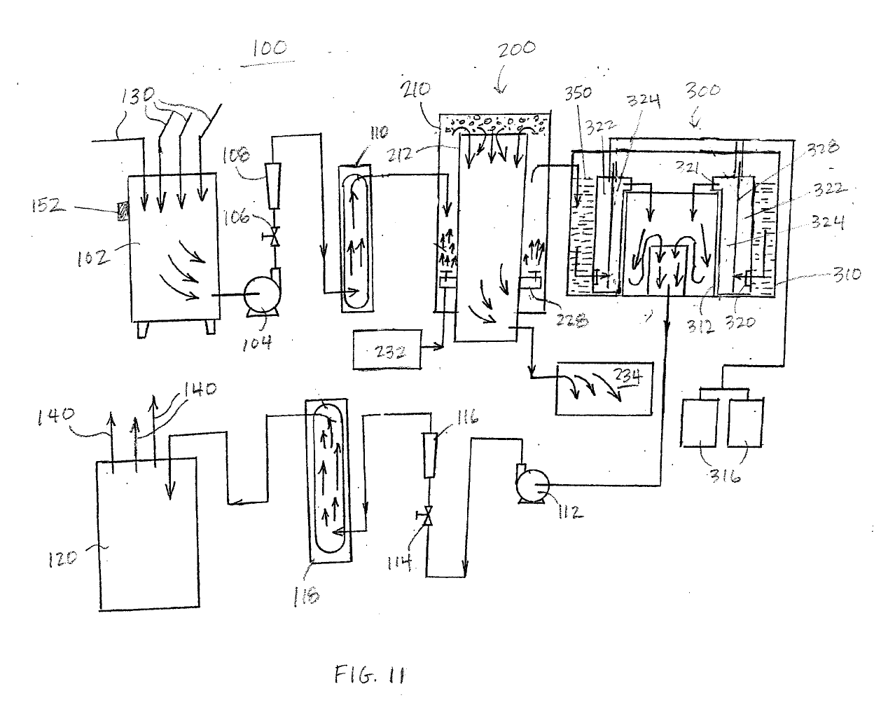

A plurality of electrochemical reactor cells 313 can be arranged together within the module housing 301 of the electrochemical reactor module 300 in order to achieve improved process throughput. Referring now to FIGS. 9 and 10, the module housing 301 is formed of a pair of concentric hollow cylinders joined at their respective lower ends to form an annular trough.

A bottom surface 304 closes the lower side of the module housing 301, and extends between a lower end of the external cylinder wall 310 and a lower end of the internal cylinder wall 312. The height of the external cylinder wall 310 is greater than height of the housing 314 of the electrochemical reactor cells 313, and the height of the internal cylinder wall 312 is less than the height of the housing 314 of the electrochemical reactor cells 313. In particular, an upper edge of the internal cylinder wall 312 terminates at a height that is below that of the outlet opening 321. As seen in FIGS. 9 and 10, in which the power supply 316, the electrodes 322, 324, and membrane 328 for each electrochemical reactor cell 313 are omitted for purposes of clarity, when electrochemical reactor cells 313 are disposed within the module housing 301, the radial distance d₁ between the internal cylinder wall 312 and the external cylinder wall 310 is greater than the corresponding dimension d₂ of the trough in the radial direction. In addition, the electrode cells are arranged within the trough so that a cavity 334 is provided between the external cylinder wall 310 and the confronting surface of the housing 314 of each electrochemical reactor cell 313.

The cavity 334 between the electrochemical reactor cell 313 and the external cylinder wall 310 is filled with liquid delivered from the separator 200, that is, liquid containing metals in solution. The level of the liquid in the module housing 301 is sufficient to create internal pressure forces acting under the influence of gravity (head) that press the liquid into the inlet openings of the respective cells 313. In addition, a sensor 352 is provided to determine the level of liquid in the module housing 301, and the level of the liquid in the module housing 301 is regulated to an upper limit which is less than the height of the housing 314 of each electrochemical reactor cell 313.

Under the influence of gravity, the liquid is forced to enter inlet opening 320 of the electrochemical reactor cell 313, passes through the volume of the anodic electrode 322, the membrane 328, and the volume of the cathodic electrode 324, to effect the removal of metal ions from the liquid. A processed liquid Lₒᵤₜ, that is, a liquid that is substantially without metals in solution, exits outlet opening 321 of the cell 313. The housing 314 of the cell 313 is arranged to abut the internal cylinder wall 312 of the module housing 301 such that the outlet opening 321 faces radially inward. As a result, the liquid exiting from the outlet opening 321 is directed into the open internal space 318 within the internal cylinder wall 312, which provides an outlet for the module housing 301.

Referring again to FIG. 1, the outlet 318 of the module housing 301 is connected with a pump 112, whereby liquid is drawn from the electrochemical reactor module 300 and directed through a flow rate adjustment valve 114 and a flow meter 116, to an inlet of a second mechanical filter 118.

The second mechanical filter 118 includes a screen configured to remove sediments and other non-dissolved particulate matter from the liquid. The filtering properties (e.g., pore size) of the filter 100 are selected based on the requirements of the specific application. In some embodiments, the filtering properties of the second mechanical filter 118 are more restrictive than that those of filter 110. By passing the liquid through the mechanical filter 118, fine sediments and other remaining non-dissolved particulate matter are removed from the liquid received from the electrochemical reactor module 300.

Liquid that has been filtered through the second mechanical filter 118 is then directed into a reservoir 120 intended for collecting the treated liquid.

Although not specifically described herein, the apparatus 100 is equipped with various sensors at appropriate locations to detect the characteristics of the liquid, which may include, but are not limited to, electrical conductivity, density, acidity, alkalinity, flow rates, temperature, and viscosity. In addition, the apparatus 100 is equipped with sensors to detect the operation and status of the pumps 204, 112, filters 110, 118, separator 200, electrochemical reactor module 300, and other conventional ancillary and auxiliary components of the system. The apparatus 100 is also equipped with a controller 150 which controls operation of the pumps 204, 112, filters 110, 118, separator 200, electrochemical reactor module 300, and the other conventional ancillary and auxiliary components of the system based on sensor input (FIG. 7).

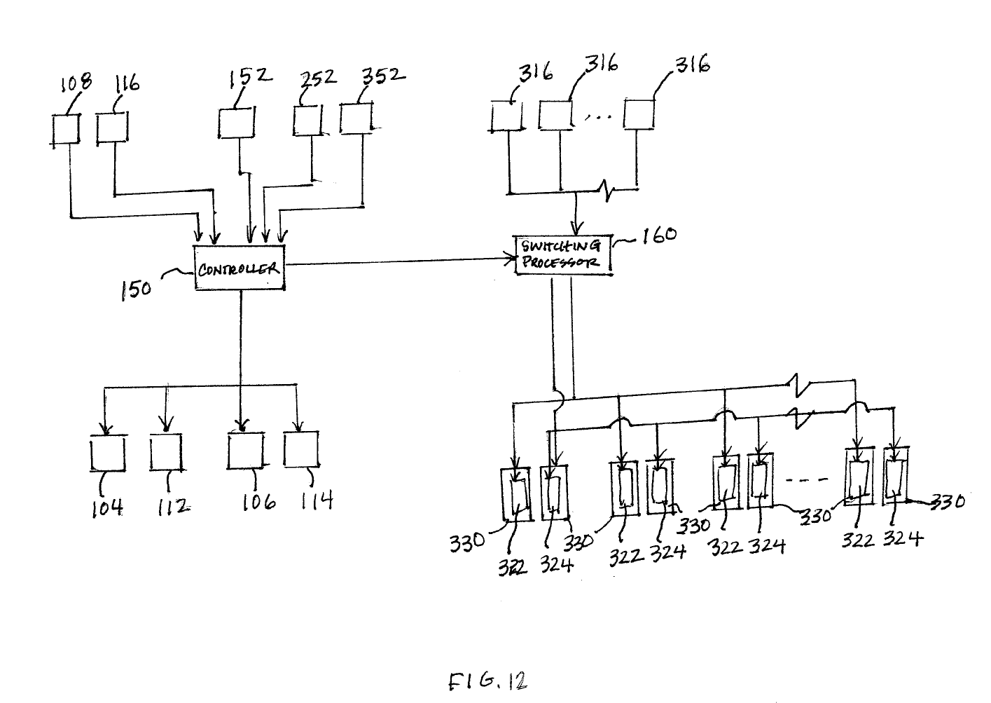

The process of complex treatment of liquids is now described with reference to FIG. 11. Input ducts 130 are provided which supply the contaminated liquid solution to the input reservoir 102. Contaminated liquid, for example waste from technological processes, is accumulated within the input reservoir 101 until the level of liquid therein achieves a predetermined level as detected by a sensor 152. When the level of liquid within the input reservoir 102 reaches the predetermined level, the pump 104 commences operation and drives the liquid to the first mechanical filter 110 along the line comprising the adjustment valve 106 and the flow meter 108.

The first mechanical filter 110 filters sediments and other non-dissolved particulate from the liquid.

From the mechanical filter 110, the filtered liquid is supplied to the separator device 200, which separates the organic substances and non-metallic impurities from the liquid. Within the separator 200, the liquid enters the annular gap between the outer cylindrical housing 210 and the inner cylindrical housing 212. The level of the liquid within the separator trough 250 gradually rises up to a level sensor 252 that issues a signal for turning on the compressor 232, which supplies compressed air to the activator units 228 that operate to form local areas of micro-bubbles 238, so that the layer 236 of steady foam is formed within a short period of time. The speed of the liquid rise is so calculated that the liquid undergoes a flotation treatment over a period of about 40 minutes, which is sufficient for the separation organic and other nonmetallic impurities from the main volume of liquid. The foam 236 rises up to the upper part of the coaxial separator device 200, flows into the internal cavity 214 of the inner cylindrical housing 212, and is then stored.

The liquid separated from the foamed impurities is supplied to the cavity 334 formed within the electrochemical reactor module 300. The level of liquid within the cavity 334 is permitted to rise to a predetermined level 350, as detected by a sensor 352. At the same time, in accordance with the law of communicating vessels, the liquid enters the input opening 320. Concurrent with the liquid's rising within the annular trough 334, its level also rises in each of the electrochemical reactors 313 up to the level of the output openings 321. In the course of the rise, electrical current is applied to the electrodes 322, 324 from the power supply units 316, so that the stream of liquid passing through the reactor housing 314 is electrochemically treated. Specifically, an electrolytic process is performed which results in galvanic deposition of metals on the active working surface of the cathodic electrode 324 within each electrochemical reactor cell 313. The liquid that has undergone the electrolytic treatment flows from outlet opening 321 of the cell 313, and is directed into the open internal space 318 within the internal cylinder wall 312. The liquid is then driven by the pump 112 along the conduit which includes the adjustment valve 114, the flow meter 116, to the second mechanical filter 118.

The second mechanical filter 118 filters sediments and other non-dissolved particulate from the liquid.

From the second mechanical filter 118, the filtered liquid is supplied to the collecting reservoir 120. Liquid accumulated within the collecting reservoir is substantially free of organic and inorganic substances including metal ions. Thus, the liquid is directed, via ducts 140, to external systems and processes where it is reused.

A selected illustrative embodiment of the invention has been described above in some detail. It should be understood that only structures considered necessary for clarifying the present invention have been described herein. Other conventional structures, and those of ancillary and auxiliary components of the system, are assumed to be known and understood by those skilled in the art. Moreover, while a working example of the present invention has been described above, the present invention is not limited to the working example described above, but various design alterations may be carried out without departing from the present invention as set forth in the claims. Other combinations of treatment devices including separator devices and electrochemical reactor modules, as well as alternative embodiments of foam generators and/or electrochemical reactors, as described in PCT/U.S.08/075,378 and PCT/______ ((attorney docket 30029-002WO1), are contemplated and may be employed.

1. A method of treating a liquid solution, the method comprising:
separating organic substances and non-conductive substances from the liquid solution; and
subsequent to separating organic substances and non-conductive substances from the liquid solution, electrochemically treating the liquid solution such that conductive substances are removed from the liquid solution.

2. The method of claim 1, wherein electrochemically treating the liquid solution comprises passing the liquid solution through a reactor,
the reactor comprising a pair of volume-porous electrodes separated by a neutral membrane, the electrodes being electrically connected to a source of electric potential such that one electrode is anodic and the other electrode is cathodic,
wherein the liquid solution passes through a volume of each respective electrode of the electrode pair, whereby galvanic deposition of conductive substances on an active working surface of the cathodic electrode occurs.

3. The method of claim 1, wherein separating comprises
generating violent agitation within the liquid such that a foam comprising the organic substance and the non-conductive substance is formed on a surface of the liquid.

4. The method of claim 1, wherein subsequent to electrochemical treatment, the method further comprises outputting a treated liquid that is substantially free of organic substances, non-metallic impurities, and metal ions.

5. The method of claim 1, wherein the method is a reagent-free method such that no reagents are added during the method to enhance any of separation and electrochemical treatment.

6. The method of claim 1, wherein prior to separating an organic substance and a non-conductive substance from the liquid solution, the method further comprises directing a stream of the liquid solution through a filter to generate a filtered liquid.

7. The method of claim 1, wherein the liquid solution comprises conductive and non-conductive substances.

8. The method of claim 1, wherein the liquid solution comprises at least some of conductive substances, non-conductive substances, ions of heavy metals, organic substances, and inorganic substances.

9. A method of electrochemical regeneration of a liquid, the method comprising:
providing the liquid, the liquid comprising an aqueous solution that includes at least ions of heavy metals,
selectively separating organic substances and non-conductive inorganic substances out of the liquid to form a modified solution; and
subsequent to separating the organic substances and non-conductive inorganic substances out of the liquid, electrochemically treating the modified solution by using gravitational force to drive the modified solution through a pair of permeable electrodes of opposed charge, the electrodes separated by a neutral membrane.

10. The method of claim 9, wherein the aqueous solution further includes organic substances and inorganic substances.

11. The method of claim 9, wherein the pair of permeable electrodes comprises volume-porous electrodes, each electrode comprising a volume configured to permit fluid through-flow in three orthogonal directions.

12. The method of claim 9, wherein selectively separating organic substances and non-conductive inorganic substances from an aqueous solution comprises generating flotation within the aqueous solution such that the liquid separates into the modified solution and a second solution comprising the organic substances and non-conductive inorganic substances.

13. The method of claim 9, wherein selectively separating organic substances and non-conductive inorganic substances from an aqueous solution comprises generating flotation within the aqueous solution such that the liquid separates into the modified solution and a second solution comprising the organic substances and non-conductive inorganic substances, wherein the flotation generation is achieved without addition of chemical reagents to the aqueous solution.

14-25. (canceled)

26. An apparatus for wastewater treatment,
the wastewater comprising an aqueous solution including metals and metal ions, organic substances, and inorganic substances,
the apparatus comprising:
an aeration module configured to provide selective separation of organic and non-electrically conducting inorganic components of the aqueous solution from the aqueous solution;
an electrochemical module, the electrochemical module connected to the aeration module such that wastewater treated within the aeration module is hydraulically driven to the electrochemical module;
a power supply; and
a control module which coordinates operation of the aeration module with operation of the electrochemical module;
wherein the electrochemical module comprises at least one pair of volume porous electrodes, the volume-porous electrodes each connected with the power supply by an electrically-conductive contact such that one electrode of an electrode pair is an anode and the other electrode of the electrode pair is a cathode, and
the electrochemical module is configured to provide electrical deposition of metals from the wastewater treated within the aeration module such that the metals deposit onto a surface of the cathode.

27. The apparatus of claim 26, wherein the contact comprises an elastic, liquid-permeable, nonmetallic fabric.

28. The apparatus of claim 26, wherein the control module is configured to provide a pulsed source of electrical power to the electrodes.

29-43. (canceled)
